(19) United States
(12) Patent Application Publication
(10) Pub. No.: US 2025/0069111 A1
(43) Pub. Date: Feb. 27, 2025

(54) STORE EXITING MANAGEMENT SYSTEM, STORE EXITING MANAGEMENT METHOD, AND RECORDING MEDIUM

(71) Applicant: NEC Corporation, Minato-ku, Tokyo (JP)

(72) Inventors: Rumi Ikezawa, Tokyo (JP); Tadamasa Yokoyama, Tokyo (JP)

(73) Assignee: NEC Corporation, Minato-ku, Tokyo (JP)

(21) Appl. No.: 18/724,233

(22) PCT Filed: Jan. 28, 2022
(86) PCT No.: PCT/JP2022/003283

§ 371 Date: Jun. 26, 2024

(51) Int. Cl. G06Q 30/0207; G06Q 30/0226

(52) U.S. Cl. CPC G06Q 30/0237; G06Q 30/0226

(57) ABSTRACT

A store exiting management system comprising a store exiting information acquisition unit, a specification unit, and a granting unit. The store exiting information acquisition unit acquires store exiting information from a terminal device after payment for products registered by customer operations on the terminal device has been completed. The specification unit specifies an incentive corresponding to the acquired store exiting information. The granting unit grants the customer the specified incentive.

### TECHNICAL FIELD

The present disclosure relates to a store exiting management system and the like.

### BACKGROUND ART

There is scan shopping in which a product is registered by an operation of a customer on a terminal device.

For example, PTL 1 describes a technique in which an accounting terminal of a store calculates a payment amount based on discount information of a coupon ticket transmitted from a user terminal.

For example, PTL 2 describes a technique in which a user terminal selects a coupon and transmits the coupon to a benefit providing device, and the benefit providing device makes a payment with an amount after application of the coupon.

For example, PTL 3 describes a technique in which a mobile terminal displays store exiting information in a case where payment is made via the mobile terminal. Then, for example, PTL 3 describes a technique in which a store terminal reads store exiting information displayed on a mobile terminal to infer whether a customer has completed payment when exiting the store.

### CITATION LIST

### Patent Literature

PTL 1: JP 2014-038539 A
PTL 2: JP 2020-154682 A
PTL 3: JP 2021-135525 A

### SUMMARY OF INVENTION

### Technical Problem

For example, store exiting processing is performed in which a reading device installed in a store reads store exiting information from a terminal device operated by a customer after payment completion. However, the customer may feel troublesome to perform the store exiting processing.

An object of the present disclosure is to provide a store exiting management system and the like that improve motivation of a customer to perform store exiting processing.

### Solution to Problem

A store exiting management system according to an aspect of the present disclosure includes: a store exiting information acquisition means for acquiring store exiting information from a terminal device after a product is registered via an operation of a customer on the terminal device and payment of the registered product is completed; a specification means for specifying an incentive corresponding to the acquired store exiting information; and a granting means for granting the specified incentive to the customer.

A store exiting management method according to an aspect of the present disclosure includes: acquiring store exiting information from a terminal device after a product is registered via an operation of a customer on the terminal device and payment of the registered product is completed; specifying an incentive corresponding to the acquired store exiting information; and granting the specified incentive to the customer.

A program according to an aspect of the present disclosure causes a computer to execute processing including: acquiring store exiting information from a terminal device after a product is registered via an operation of a customer on the terminal device and payment of the registered product is completed; specifying an incentive corresponding to the acquired store exiting information; and granting the specified incentive to the customer.

The program may be stored in a non-transitory computer-readable recording medium.

### Advantageous Effects of Invention

According to the present disclosure, it is possible to improve motivation of a customer to perform store exiting processing.

### BRIEF DESCRIPTION OF DRAWINGS

FIG. 1 is a block diagram illustrating a configuration example of a store exiting management system according to a first example embodiment.

FIG. 2 is a flowchart illustrating an operation example of the store exiting management system according to the first example embodiment.

FIG. 3 is an explanatory diagram illustrating an example of store exiting processing in a store exiting counter.

FIG. 4 is an explanatory diagram illustrating an example of connection between a store exiting management system according to a second example embodiment and each device.

FIG. 5 is a block diagram illustrating a configuration example of the store exiting management system according to the second example embodiment.

FIG. 6 is a block diagram illustrating a configuration example of a terminal device.

FIG. 7 is an explanatory diagram illustrating an example of a screen displayed on a display device installed in the store exiting counter.

FIG. 8 is an explanatory diagram illustrating a first display example of a store exiting code.

FIG. 9 is an explanatory diagram illustrating a second display example of the store exiting code.

FIG. 10 is an explanatory diagram illustrating an example in which a name of a customer is displayed on the display device after the store exiting code is acquired.

FIG. 11 is an explanatory diagram illustrating an example in which information regarding a member rank of the customer is displayed on the display device after the store exiting code is acquired.

FIG. 12 is an explanatory diagram illustrating an example in which a coupon code is displayed on the display device.

FIG. 13 is a flowchart illustrating an operation example of the store exiting management system in a case where a paper coupon is issued.

FIG. 14 is a flowchart illustrating an operation example of the terminal device in a case where the paper coupon is issued.

FIG. 15 is a flowchart illustrating an operation example of a reading device in a case where the paper coupon is issued.

FIG. 16 is a flowchart illustrating an operation example of the display device in a case where the paper coupon is issued.

FIG. 17 is a flowchart illustrating an operation example of a printing device in a case where the paper coupon is issued.

FIG. 18 is a flowchart illustrating an operation example of the store exiting management system in a case where an electronic coupon is notified.

FIG. 19 is a flowchart illustrating an operation example of the terminal device in a case where the electronic coupon is notified.

FIG. 20 is a flowchart illustrating an operation example of the store exiting management system in a case where the electronic coupon is acquired via the display device.

FIG. 21 is a flowchart illustrating an operation example of the terminal device in a case where the electronic coupon is acquired via the display device.

FIG. 22 is a flowchart illustrating an operation example of the display device in a case where the electronic coupon is acquired via the display device.

FIG. 23 is an explanatory diagram illustrating an example in which a coupon candidate is displayed on the terminal device during product registration.

FIG. 24 is an explanatory diagram illustrating an example in which a coupon granting condition is displayed on the terminal device during product registration.

FIG. 25 is a flowchart illustrating an operation example of the store exiting management system during product registration.

FIG. 26 is a flowchart illustrating an operation example of the terminal device during product registration.

FIG. 27 is an explanatory diagram illustrating an example of performing store exiting processing in a flapper gate.

FIG. 28 is a block diagram illustrating a configuration example of a store exiting management system in a first modification.

FIG. 29 is an explanatory diagram illustrating a hardware configuration example of a computer.

### EXAMPLE EMBODIMENT

Hereinafter, an example embodiment of a store exiting management system, a store exiting management method, a program, and a non-transitory recording medium recording the program according to the present disclosure will be described in detail with reference to the drawings. The present example embodiment does not limit the disclosed technology.

### First Example Embodiment

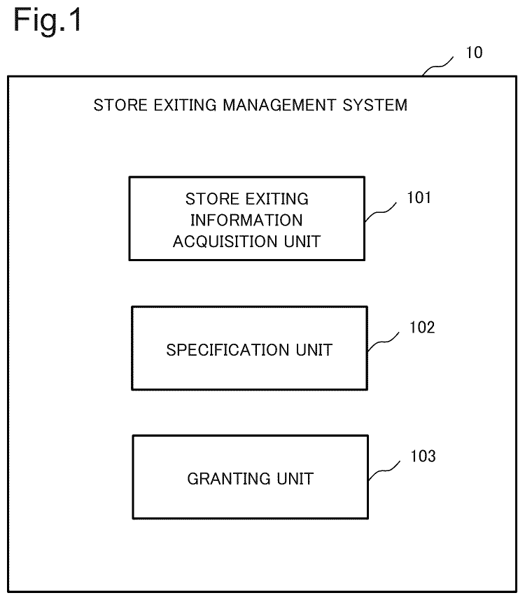

First, in a first example embodiment, a basic function of the store exiting management system will be described. FIG. 1 is a block diagram illustrating a configuration example of the store exiting management system according to the first example embodiment. A store exiting management system 10 includes a store exiting information acquisition unit 101, a specification unit 102, and a granting unit 103.

The store exiting information acquisition unit 101 acquires store exiting information from a terminal device after a product is registered by an operation of a customer on the terminal device, and payment for the registered product is completed. The terminal device is a device operable by the customer. The store exiting information may include customer identification information for identifying the customer, or may include a code associated with the customer identification information. Accordingly, it is possible to identify which customer is performing store exiting processing. In addition, the store exiting information may be represented by, for example, a code such as a number or a character. Here, a code representing the store exiting information is referred to as a store exiting code. The store exiting code may be represented by a one-dimensional code or a two-dimensional code. Note that the customer identification information is not particularly limited as long as it can uniquely identify the customer.

As a method by which the store exiting information acquisition unit 101 acquires the store exiting information from the terminal device, the store exiting information acquisition unit 101 acquires the store exiting code by reading the store exiting code displayed on the terminal device by a reading device installed in the store. Alternatively, as another method, the store exiting information acquisition unit 101 may acquire the store exiting code by the reading device receiving the store exiting code from the terminal device by near field communication between the reading device installed in the store and the terminal device. Alternatively, as another method, the store exiting information acquisition unit 101 may acquire the store exiting code by receiving an input of the store exiting code displayed on the terminal device by the operation of the customer on the input device installed in the store.

Here, the store may be, for example, a store such as a supermarket, a supermarket center, a convenience store, a mass merchandise store, a home center, a drug store, a store that handles apparel products, or an individual store such as a bakery or a daily dish store, and is not particularly limited.

The specification unit 102 specifies an incentive corresponding to the acquired store exiting information. The type of incentive is not particularly limited, for example, a coupon, a point, or the like.

For example, an incentive in a case where the store exiting information is acquired may be determined in advance. Specifically, for example, an incentive in a case where the store exiting processing is performed is determined in advance, and the specification unit 102 specifies the incentive corresponding to the store exiting information.

Alternatively, for example, the specification unit 102 specifies the incentive depending on whether payment has been made via the terminal device. More specifically, for example, the specification unit 102 specifies an incentive such that the incentive is higher in a case where payment is made via the terminal device than in a case where payment is made via a settlement device.

Alternatively, for example, the specification unit 102 may specify the incentive corresponding to the amount of payment. For example, the specification unit 102 specifies an incentive such that the higher the amount of payment, the higher the incentive. More specifically, for example, an incentive corresponding to the amount of money is tabulated in advance, and the specification unit 102 may specify the incentive corresponding to the amount of payment from the table.

Alternatively, the specification unit 102 may specify the incentive corresponding to the number of times of payment via the terminal device. The number of times is counted, for example, for each customer. For example, the specification unit 102 specifies an incentive such that the incentive increases as the number of times increases. More specifically, for example, the incentive corresponding to the number of times may be tabulated in advance, and the specification unit 102 may specify the incentive corresponding to the number of times from the table.

Alternatively, the specification unit 102 may specify the incentive corresponding to the number of times the store exiting information has been acquired. The number of times is counted, for example, for each customer. The number of times the store exiting information has been acquired is the number of times the store exiting processing has been performed. For example, the specification unit 102 specifies an incentive such that the incentive increases as the number of times increases. More specifically, for example, the incentive corresponding to the number of times may be tabulated in advance, and the specification unit 102 may specify the incentive corresponding to the number of times from the table.

Alternatively, for example, in a case where a member rank is granted to the customer, the specification unit 102 may specify the incentive corresponding to the member rank specified by the customer identification information obtained based on the store exiting information. Specifically, for example, in a case where the store exiting information includes the customer identification information, the specification unit 102 specifies the incentive corresponding to the member rank specified by the customer identification information obtained based on the store exiting information. For example, in a case where the store exiting information includes a code associated with the customer identification information, the specification unit 102 specifies the incentive corresponding to the member rank specified by the customer identification information associated with the code included in the store exiting information. More specifically, for example, the specification unit 102 specifies an incentive such that the higher the member rank, the higher the incentive. The reference of the member rank is not particularly limited, but for example, the member rank is determined by the purchase amount for each predetermined period, the number of times of use of the store for each predetermined period, and the like.

Then, the granting unit 103 grants the customer the specified incentive. A method of the granting unit 103 granting an incentive differs depending on the type of incentive. For example, in a case where the incentive is a point, the granting unit 103 may add a specified point value to the point value associated with the customer identification information. For example, in a case where the incentive is a coupon, the granting unit 103 may issue a coupon. Note that the coupon may be a paper coupon or an electronic coupon. The coupon is a coupon that can be used in subsequent shopping. A coupon issuance example will be described with a specific example in a second example embodiment.

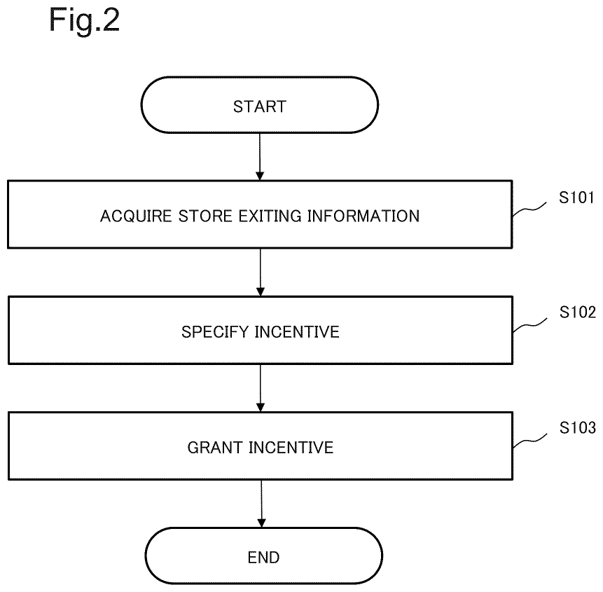

FIG. 2 is a flowchart illustrating an operation example of the store exiting management system 10 according to the first example embodiment. The store exiting management system 10 acquires the store exiting information (step S101). The store exiting management system 10 specifies the incentive corresponding to the store exiting information (step S102). Then, the store exiting management system 10 grants an incentive (step S103).

As described above, in the first example embodiment, in a case where the store exiting information is acquired from the terminal device of the customer, the store exiting management system 10 grants the customer the incentive corresponding to the store exiting information. In this way, the incentive is granted, so that it is possible to improve motivation of the customer to perform the store exiting processing. In addition, in the case of a store exiting counter without a gate, there is a case where a customer exits a store without performing the store exiting processing. According to the store exiting management system 10, it is possible to more reliably cause the customer to perform the store exiting processing.

### Second Example Embodiment

Next, a second example embodiment will be described in detail with reference to the drawings. In the second example embodiment, by using a coupon as an example of an incentive, an example of specifying each coupon and an example of granting the coupon will be described in detail. Hereinafter, description of contents overlapping with the above description will be omitted to the extent that the description of the second example embodiment is not unclear.

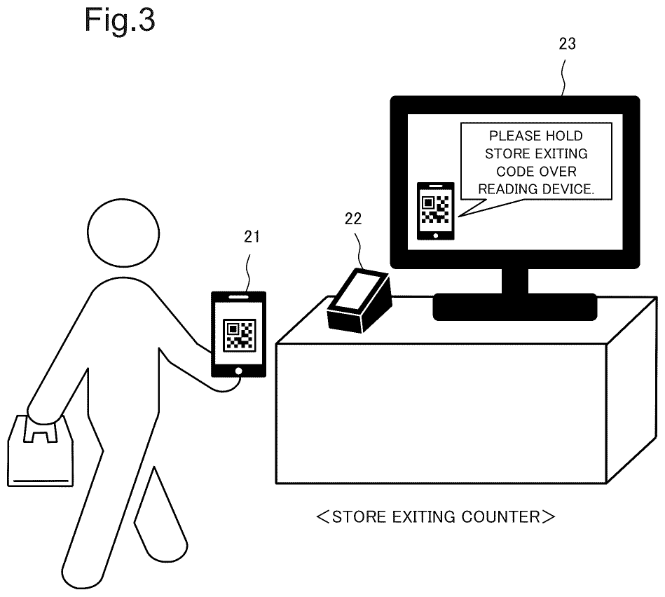

FIG. 3 is an explanatory diagram illustrating an example of the store exiting processing in a store exiting counter. A display device 23 and a reading device 22 are installed in the store exiting counter. The display device 23 may display, for example, guidance to customers.

For example, after payment completion, the customer goes to the store exiting counter before exiting the store. Then, the terminal device 21 operable by the customer displays a store exiting code. In FIG. 3, the store exiting code is represented by a two-dimensional code. The store exiting code is held over the reading device 22 by the customer. Then, the reading device 22 reads the store exiting code from the terminal device 21. In this manner, the store exiting processing is performed. Note that, in the case of the store exiting counter without a gate as illustrated in FIG. 3, there is a case where the customer exits the store without performing the store exiting processing.

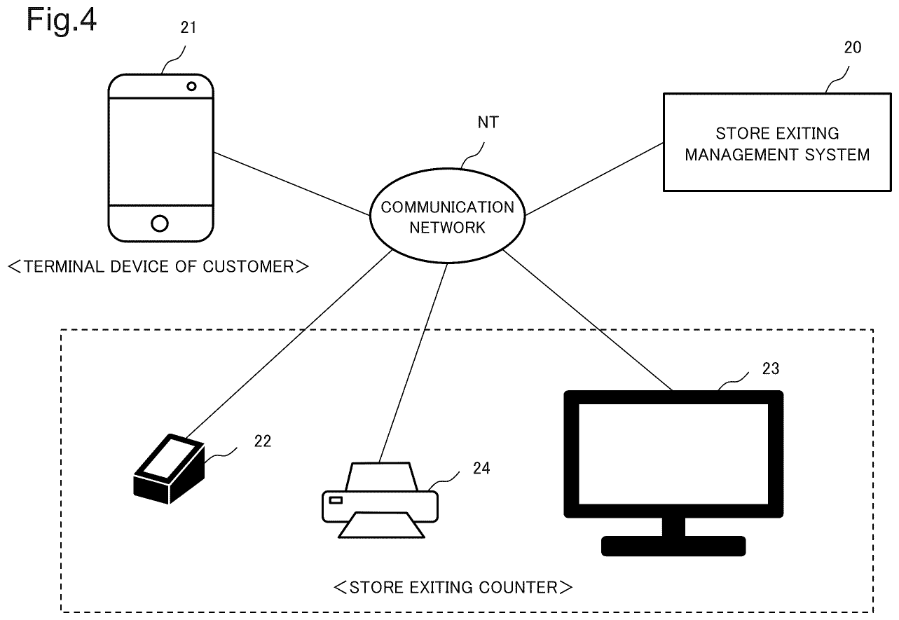

FIG. 4 is an explanatory diagram illustrating an example of connection between the store exiting management system according to the second example embodiment and each device. The store exiting management system 20 is connected to, for example, the terminal device 21, the reading device 22, the display device 23, a printing device 24, and the like via a communication network NT. Although one communication network NT is described as an example for ease of description, the store exiting management system 20 may be connected to each device by a different communication network NT.

The terminal device 21 is a device operable by the customer and is a device portable by the customer. For example, the terminal device 21 performs product registration by the operation of the customer. The type of the terminal device 21 is not particularly limited, and may be a smartphone, a tablet-type device, a device dedicated to the store, or the like. For example, it is assumed that an application program for shopping in the store is installed in the terminal device 21 in advance. Then, the terminal device 21 exchanges various types of information with the store exiting management system 20 via the application program.

The reading device 22, the display device 23, and the printing device 24 are installed in the store exiting counter. The reading device 22 is a device capable of reading a store exiting code. In addition, the reading device 22 may be a device that reads a store exiting code by wireless communication with the terminal device 21, or may be a device that can read a one-dimensional code or a two-dimensional code.

The display device 23 displays various types of information under the control of the store exiting management system 20. The printing device 24 is a device that issues a paper coupon or the like.

A store exiting terminal device (not illustrated) may be installed in the store exiting counter, and the store exiting terminal device may include the reading device 22, the display device 23, and the printing device 24. In addition, a voice output device such as a speaker may be connected.

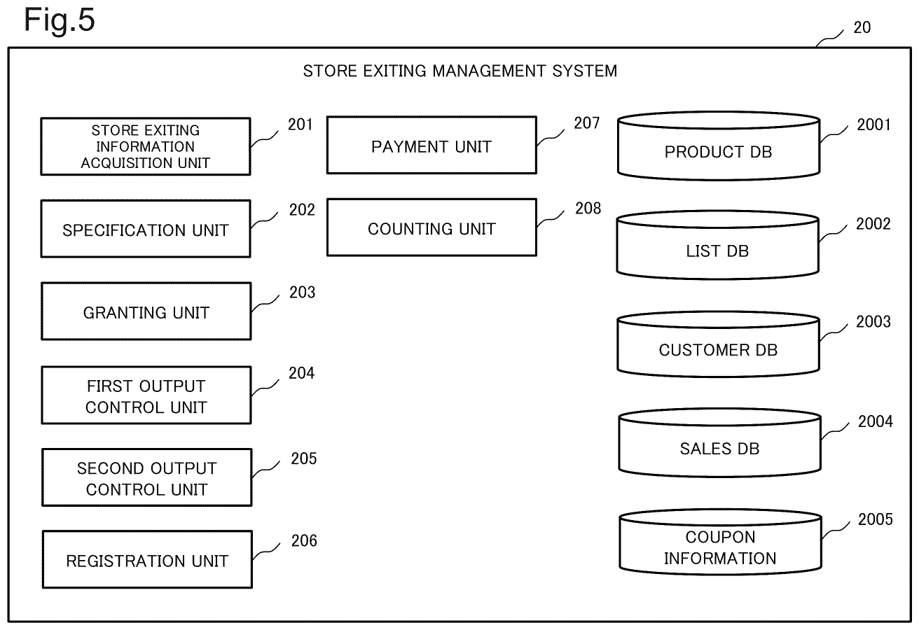

FIG. 5 is a block diagram illustrating a configuration example of the store exiting management system 20 according to the second example embodiment. The store exiting management system 20 includes a store exiting information acquisition unit 201, a specification unit 202, a granting unit 203, a first output control unit 204, a second output control unit 205, a registration unit 206, a payment unit 207, and a counting unit 208. In the store exiting management system 20, the first output control unit 204, the second output control unit 205, the registration unit 206, the payment unit 207, and the counting unit 208 are further added to the store exiting management system 20 according to the first example embodiment. The store exiting information acquisition unit 201 has the basic function of the store exiting information acquisition unit 201 according to the first example embodiment. The specification unit 202 has the basic function of the specification unit 202 according to the first example embodiment. The granting unit 203 has the basic function of the granting unit 203 according to the first example embodiment.

The store exiting management system 20 includes a product database (DB) 2001, a list DB 2002, a customer DB 2003, a sales DB 2004, and coupon information 2005.

The product DB 2001 stores product identification information and product information for each product in association with each other. For example, in a case where the product identification information is a product code, the product information is information such as a name of the product and a price of the product, and is not particularly limited.

The list DB 2002 stores, for each customer, the latest list on which payment has not been completed. For example, the list stores, for each customer, customer identification information for identifying a customer, identification information (for example, the product code) of a product that the customer intends to purchase, and information of a purchase quantity in association with each other. The customer identification information is not particularly limited as long as the customer identification information can uniquely identify the customer, and is, for example, the name of the customer, the telephone number of the customer, the e-mail address of the customer, and the like. For example, before starting registration of a product to a new customer, the customer identification information such as a customer identifier (ID) may be granted to the customer. Note that in a case where there is a member ID such as a point card number or a member number, the member ID may be used as the customer identification information. In addition, the list DB 2002 may store a list for each transaction. For example, in a case where a list is stored for each transaction, transaction identification information may be granted instead of the customer identification information. Note that the list may be referred to as a shopping basket.

The customer DB 2003 stores information regarding a customer for each customer. For example, the customer DB 2003 stores the customer identification information for identifying a customer and information regarding the customer in association with each other for each customer. The customer identification information is not particularly limited as long as the customer can be uniquely identified. For example, although a customer ID will be described as an example of the customer identification information, the customer identification information may be information such as a member ID of a customer, a name of the customer, and a contact address such as a telephone number or an e-mail address of the customer. Note that in a case where the customer ID is the customer identification information, the member ID of the customer, the name of the customer, the contact address of the customer, and the like may be information related to the customer. In addition, for example, the information regarding the customer may be a member rank of the customer, information related to the member rank, the number of times of store exiting processing performed by the customer, the number of times of payment performed by the customer via the terminal device 21, a granted coupon or the use status of the coupon, and the like. The member rank is a rank assigned to each customer according to a predetermined standard. The member rank may be determined by the purchase amount or the number of purchases, and is not particularly limited. The information related to the member rank is information necessary for determining the member rank. For example, in a case where the member rank is determined for each month by a monthly total purchase amount, the information related to the member rank is, for example, a monthly total amount.

The sales DB 2004 stores, for example, information regarding sales. For example, the sales DB 2004 may manage information corresponding to each transaction. For example, the sales DB 2004 stores information of the customer identification information, identification information of a purchased product, a purchase quantity for each product, an amount of payment by each payment method, information regarding whether payment has been made via the terminal device 21 or via a settlement device, identification information of the settlement device in a case where payment has been made via the settlement device, and a purchase date and time in association with each other.

The coupon information 2005 is information indicating a coupon associated to the store exiting information. The coupon may be a discount or a product exchange, and is not particularly limited. The coupon may be uniquely determined in advance.

Alternatively, the coupon may be determined for each amount of payment. The amount of payment is also referred to as a purchase amount. Specifically, for example, the coupon may be determined such that the higher the purchase amount in the current shopping, the higher the value of the coupon. Note that the fact that the value of the coupon increases means that the incentive increases. The higher the purchase amount, the higher the incentive. To increase the value of the coupon means, for example, to increase the discount amount or to increase the price of the exchangeable product. Alternatively, the fact that the value of the coupon increases means that the exchangeable product is a product that the customer wants or a product that the customer frequently purchases. Here, specifically, for example, in a case where the coupon is a discount, the coupon may be determined in advance such that the higher the purchase amount, the higher the discount amount of the coupon. In addition, for example, in a case where the coupon is a product exchange, the coupon may be determined in advance such that the higher the purchase amount, the more expensive the product that can be exchanged for. In such a case, the coupon information 2005 may be a table in which a coupon is determined in advance for each purchase amount.

Alternatively, the coupon may be determined for each member rank. For example, the value of the coupon may be determined to be higher as the member rank is higher. More specifically, for example, in a case where the coupon is a discount, the coupon may be determined such that the higher the member rank, the higher the discount amount of the coupon. In a case where the coupon is a product exchange, the coupon may be determined such that the higher the member rank, the higher the price of the exchangeable product. In such a case, the coupon information 2005 may be a table in which a coupon is determined in advance for each member rank.

Alternatively, the coupon may be determined depending on whether payment is made via the terminal device 21. The coupon may be determined such that the value of the coupon is higher in a case where payment is made via the terminal device 21 than in a case where payment is not made via the terminal device 21. More specifically, for example, in a case where the coupon is a discount, the coupon may be determined such that the discount amount is higher in a case where payment is made via the terminal device 21 than in a case where payment is made via the settlement device. In a case where the coupon is a product exchange, the coupon may be determined such that the price of the exchangeable product is higher in a case where payment is made via the terminal device 21 than in a case where payment is made via the settlement device. As described above, in a case where a coupon is different between a case where payment is made via the terminal device 21 and a case where payment is made via the settlement device, for example, the coupon information 2005 is information indicating a coupon in a case where payment is made via the terminal device 21 and a coupon in a case where payment is made via the settlement device.

Further, the coupon may be determined such that the value of the coupon is the highest in a case where product registration and payment are performed via the terminal device 21. Specifically, for example, the discount amount of the coupon may be determined to be higher in a case where product registration and payment are performed via the terminal device 21 than in a case where the product registration is performed via the terminal device 21 and the payment is performed via the settlement device. The discount amount of the coupon may be determined to be higher in a case where the product registration is performed via the terminal device 21 and the payment is made via the settlement device than in a case where the product registration is performed via the product registration device installed in the store and the payment is made via the settlement device. That is, in the shopping, the discount amount of the coupon may be determined to increase as the number of times of processing through the terminal device 21 by the operation of the customer increases. Although the coupon has been described as an example of a discount, in a case where the coupon is a product exchange, the coupon may be determined such that the price of the exchangeable product increases in a case where the product registration and the payment are performed via the terminal device 21. Accordingly, it is possible to promote shopping via the terminal device 21.

Alternatively, the coupon may be determined by the number of times of payment via the terminal device 21. The number of times of payment via the terminal device 21 is counted for each customer, for example. The value of the coupon may be determined to be higher as the number of times of payment is larger. Specifically, for example, in a case where the coupon is a discount, the coupon may be determined such that the discount of the coupon increases as the number of times of payment via the terminal device 21 increases. Alternatively, in a case where the coupon is a product exchange, the coupon may be determined such that the price of the exchangeable product increases as the number of times of payment via the terminal device 21 increases. For example, the coupon information 2005 may be a table in which a coupon is set for each number of times.

Alternatively, the coupon may be determined by the number of times the customer has performed the store exiting processing. The number of times the customer has performed the store exiting processing is counted for each customer, for example. The value of the coupon may be determined to be higher as the number of times the customer has performed the store exiting processing is larger. More specifically, for example, in a case where the coupon is a discount, the coupon may be determined such that the discount of the coupon increases as the number of times the customer has performed the store exiting processing increases. Alternatively, in a case where the coupon is a product exchange, the coupon may be determined such that the price of the exchangeable product increases as the number of times the customer has performed the store exiting processing increases. For example, the coupon information 2005 may be a table in which a coupon is set for each number of times.

In the second example embodiment, a coupon will be described as an example, but in a case where another incentive is used, the another incentive may be similarly determined.

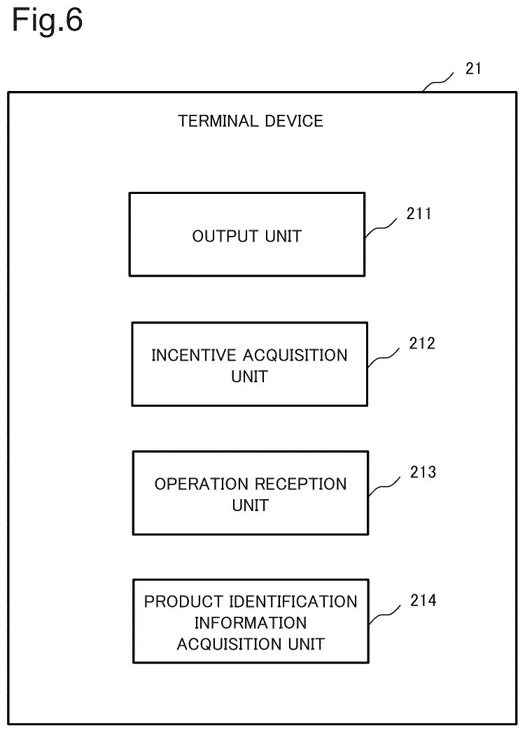

FIG. 6 is a block diagram illustrating a configuration example of the terminal device 21. The terminal device 21 includes an output unit 211, an incentive acquisition unit 212, an operation reception unit 213, and a product identification information acquisition unit 214. The output unit 211 outputs various types of information to an output device such as the display device of the terminal device 21 or the voice output device of the terminal device 21. The operation reception unit 213 receives various operations of the customer on the terminal device 21.

First, a specific example of the store exiting processing will be described.

The first output control unit 204 controls display on the display device 23. The first output control unit 204 displays guidance to the customer on the display device 23.

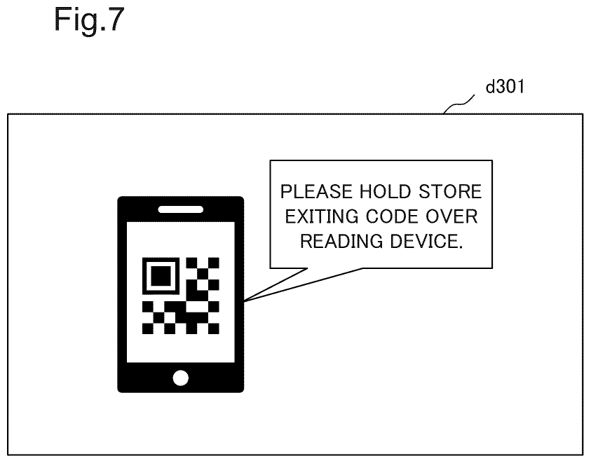

FIG. 7 is an explanatory diagram illustrating an example of a screen displayed on the display device 23 installed in the store exiting counter. The display device 23 displays a screen d301 including a guidance of “Please hold the store exiting code over the reading device 22”, for example.

The store exiting information acquisition unit 201 acquires the store exiting information from the terminal device 21 via the reading device 22. The store exiting code will be described as an example of the store exiting information.

First, an example in which the reading device 22 reads the store exiting code displayed on the terminal device 21 will be described. The second output control unit 205 controls display on the terminal device 21. For example, the second output control unit 205 displays the store exiting code on the terminal device 21. Note that the second output control unit 205 may display the store exiting code in a case where the product registration is performed via the terminal device 21 by the operation of the customer. The second output control unit 205 may display the store exiting code in a case where the product registration and the payment are performed via the terminal device 21 by the operation of the customer. Then, the output unit 211 displays the store exiting code on the display device of the terminal device 21.

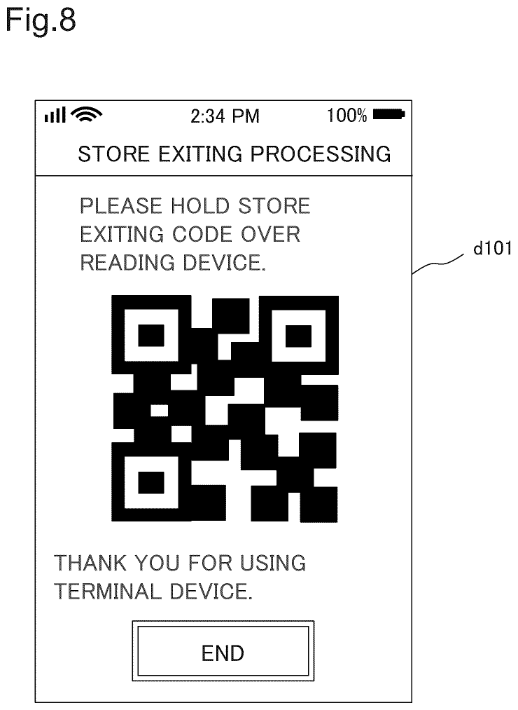

FIG. 8 is an explanatory diagram illustrating a first display example of the store exiting code. In FIG. 8, the output unit 211 displays a screen d101, which includes the store exiting code represented by a two-dimensional code, on the display device of the terminal device 21.

As illustrated in FIG. 8, the screen d101 may have an “end” button for ending the display of the screen d101 after the end of the reading of the store exiting code.

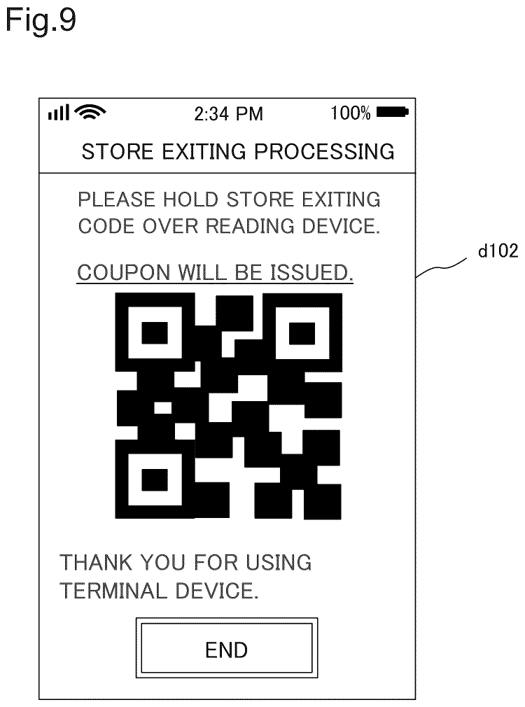

FIG. 9 is an explanatory diagram illustrating a second display example of the store exiting code. In FIG. 9, the output unit 211 displays a screen d102, which includes the store exiting code represented by a two-dimensional code, on the display device of the terminal device 21.

As illustrated in FIG. 9, the screen d102 further includes information, which indicates that a coupon is to be issued, in addition to the screen d101 illustrated in FIG. 8. Accordingly, the customer can know at a glance that the coupon can be obtained by the store exiting processing.

Specifically, the customer holds the store exiting code displayed on the terminal device 21 over the reading device 22. The reading device 22 reads the store exiting code from the terminal device 21. The reading device 22 transmits the store exiting code to the store exiting management system 20. Then, the store exiting information acquisition unit 201 can acquire the store exiting code by receiving the store exiting code from the reading device 22.

Next, another example in which the store exiting information acquisition unit 201 acquires the store exiting code from the terminal device 21 will be described. The terminal device 21 may transmit the store exiting code to the reading device 22 by near field communication between the reading device 22 and the terminal device 21. The reading device 22 receives the store exiting code from the terminal device 21. Then, the reading device 22 transmits the store exiting code to the store exiting management system 20.

Next, the specification unit 202 specifies the coupon corresponding to the store exiting information. For example, the specification unit 202 specifies a coupon based on the coupon information 2005. Here, a plurality of specific examples of the coupon will be described. Specific examples may be combined.

Alternatively, the specification unit 202 specifies the coupon corresponding to the purchase amount. Specifically, for example, the specification unit 202 specifies the coupon corresponding to the purchase amount from the coupon information 2005.

Alternatively, the specification unit 202 may specify a coupon based on the coupon information 2005 and the customer DB 2003 by the member rank specified by the customer identification information included in the store exiting information. Note that the member rank is specified by the customer DB 2003.

Alternatively, the specification unit 202 specifies a coupon depending on whether payment has been made via the terminal device 21. Specifically, for example, in a case where payment is made via the terminal device 21, the specification unit 202 specifies a coupon in this case based on the coupon information 2005. On the other hand, in a case where payment is made via the settlement device, the specification unit 202 specifies a coupon in this case based on the coupon information 2005.

Alternatively, the specification unit 202 may specify the coupon based on the number of times of payment via the terminal device 21. As described above, the number of times is counted for each customer. Note that in a case where an incentive is specified by the number of times of payment via the terminal device 21, the counting unit 208 counts the number of times for each customer and stores the counting result in the customer DB 2003. Specifically, for example, the specification unit 202 specifies, from the customer DB 2003, the number of times of payment via the terminal device 21 based on the customer identification information obtained based on the store exiting information. Then, for example, the specification unit 202 specifies, from the coupon information 2005, the coupon corresponding to the specified number of times.

Alternatively, the specification unit 202 may specify a coupon based on the number of times the customer has performed the store exiting processing. As described above, the number of times is counted for each customer. Note that, in a case where an incentive is specified by the number of times the customer has performed the store exiting processing, the counting unit 208 counts the number of times for each customer and stores the counting result in the customer DB 2003. Specifically, for example, the specification unit 202 specifies, from the customer DB 2003, the number of times the customer has performed the store exiting processing, based on the customer identification information obtained based on the store exiting information. Then, for example, the specification unit 202 specifies, from the coupon information 2005, the coupon corresponding to the number of times the customer has performed the store exiting processing.

Next, the granting unit 203 issues a coupon. Examples of the granting unit 203 issuing a coupon include an example of issuing a paper coupon, an example of notifying the terminal device 21 of an electronic coupon, and an example of causing the terminal device 21 to read the electronic coupon. Each example will be described in order.

### Example of Issuing Paper Coupon

First, an example in which a paper coupon is issued will be described.

The granting unit 203 causes the printing device 24 to print and issue a coupon. Accordingly, the printing device 24 issues a paper coupon. Then, the customer may acquire the paper coupon from the printing device 24.

In a case where the paper coupon is issued, a message from a store to a customer may be displayed on the display device 23. For example, the first output control unit 204 may acquire, from the customer DB 2003, information regarding the customer by the customer identification information included in the store exiting code, and display the information regarding the customer on the display device 23. The display device 23 displays the information on the customer. The information on the customer may be at least one of a name of the customer, a member number, a member rank, and information on the member rank, and is not particularly limited.

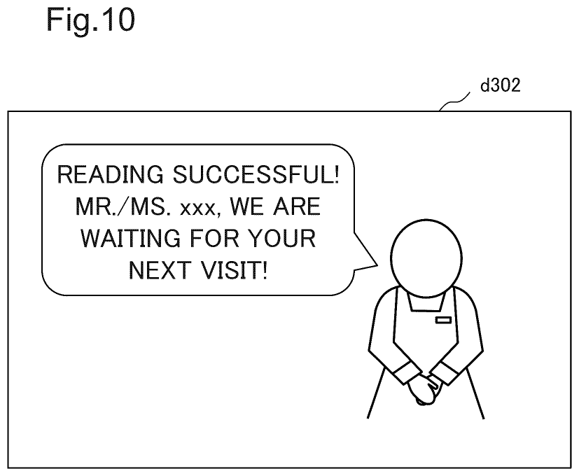

FIG. 10 is an explanatory diagram illustrating an example in which the name of the customer is displayed on the display device 23 after the store exiting code is acquired. The first output control unit 204 displays a message together with the name of the customer on the display device 23. In FIG. 10, a screen d302 including a message “Reading successful! Mr./Ms. xxx, we are waiting for your next visit!” and the name of the customer is displayed on the display device 23.

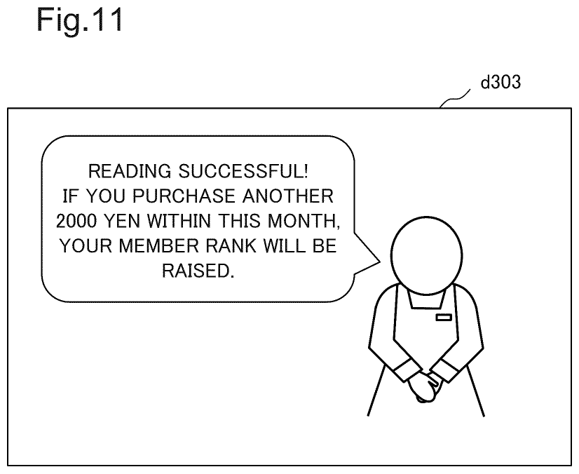

FIG. 11 is an explanatory diagram illustrating an example in which the information regarding the member rank of the customer is displayed on the display device 23 after the store exiting code is acquired. The first output control unit 204 displays the information on the member rank on the display device 23. In FIG. 11, a screen d303 including a message “Reading successful! If you purchase another 2000 yen within this month, your member rank will be raised.” and the information regarding the member rank are displayed on the display device 23.

Although not illustrated, the first output control unit 204 may displays that the paper coupon has been issued on the display device 23.

In a case where an incentive is specified by the number of times of store exiting processing, the counting unit 208 counts the number of times of store exiting processing for each customer and stores the counting result in the customer DB 2003. Note that, in a case where an incentive is specified by the number of times the store exiting processing has been performed, the counting process by the counting unit 208 is not limited to the example in which the paper coupon is issued, and is similarly performed in an example of notifying an electronic coupon and an example in which an electronic coupon is acquired via the display device 23.

### Example of Notification of Electronic Coupon

Next, an example of notifying an electronic coupon will be described. The granting unit 203 notifies the customer or the terminal device 21 of the customer of the electronic coupon. A notification method is not particularly limited. For example, the granting unit 203 notifies a specific application program executed in the terminal device 21. Alternatively, the granting unit 203 may push a notification of the coupon to the terminal device 21. Alternatively, the granting unit 203 notifies the customer of the electronic coupon by electronic mail. Alternatively, the granting unit 203 notifies the customer of the electronic coupon by an electronic message.

In a case where the electronic coupon is notified to the terminal device 21 or the customer, a message from the store to the customer may be displayed on the display device 23 as in a case where the paper coupon is issued. A display example of the display device 23 by the first output control unit 204 may be the same as that in a case where the paper coupon is issued, and thus a detailed description thereof will be omitted. In addition, although not illustrated, the first output control unit 204 may display that the electronic coupon has been notified on the display device 23.

The incentive acquisition unit 212 of the terminal device 21 may acquire the coupon by receiving the notification.

### Example of Acquiring Electronic Coupon Via Display Device 23

Next, an example of causing the terminal device 21 to acquire the electronic coupon via the display device 23 will be described. The granting unit 203 causes the display device 23 via the first output control unit 204 to display a coupon code from which the terminal device 21 can acquire the coupon.

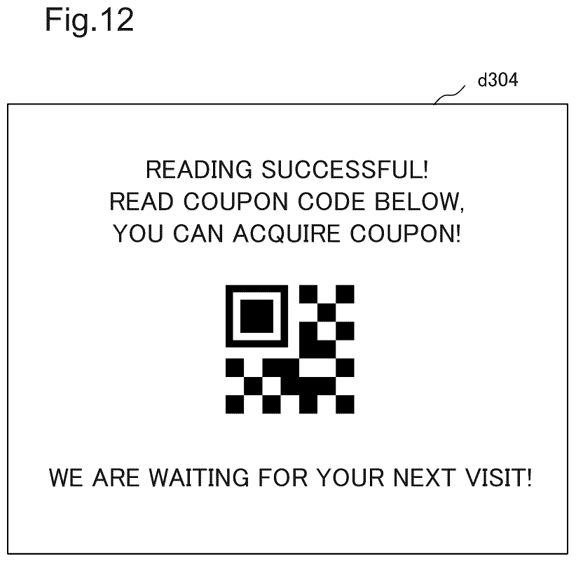

FIG. 12 is an explanatory diagram illustrating an example in which the coupon code is displayed on the display device 23. The first output control unit 204 displays the coupon code on the display device 23. In FIG. 12, a screen d304 including the coupon code is displayed on the display device 23.

Then, the incentive acquisition unit 212 of the terminal device 21 reads the coupon code via the imaging device of the terminal device 21 to acquire the coupon specified by the coupon code.

### Operation Example in Case Where Paper Coupon is Issued

First, an operation example of each device in a case where the paper coupon is issued will be described.

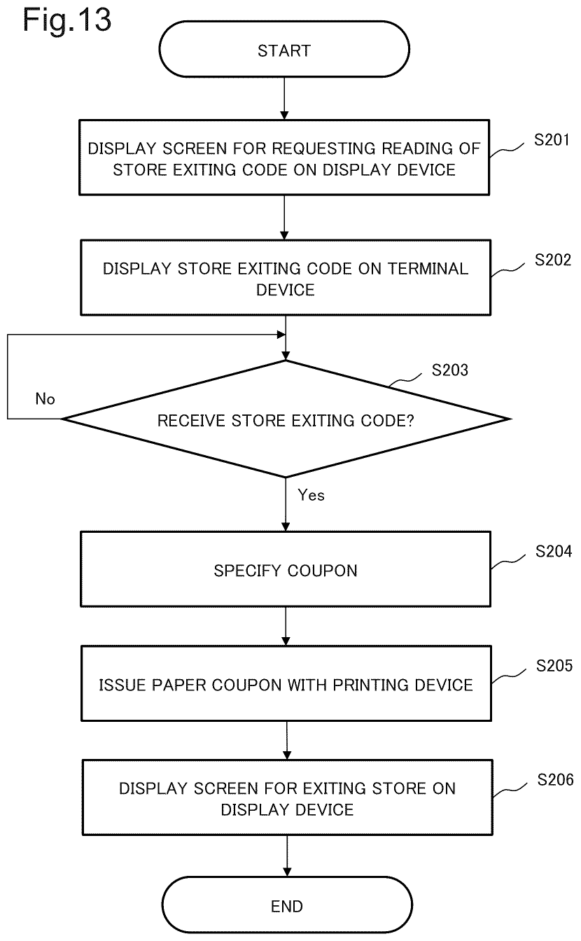

FIG. 13 is a flowchart illustrating an operation example of the store exiting management system 20 in a case where the paper coupon is issued. The first output control unit 204 displays a screen for requesting reading of a store exiting code on the display device 23 (step S201). Next, the second output control unit 205 displays the store exiting code on the terminal device 21 (step S202). The store exiting information acquisition unit 201 determines whether the store exiting code has been received (step S203). If the store exiting code has not been received (Step S203: No), the store exiting information acquisition unit 201 returns to Step S203. If the store exiting code has been received (step S203: Yes), the specification unit 202 specifies the coupon corresponding to the store exiting code (step S204).

Next, the granting unit 203 issues a paper coupon with the printing device 24 (step S205). The first output control unit 204 displays a screen for exiting the store on the display device 23 (step S206), and ends the processing. In step S206, the screen for exiting the store is a screen, which includes a message from the store to the customer after the end of the reading and information related to the customer specified by the customer identification information, such as the screen d302 illustrated in FIG. 10 or the screen d303 illustrated in FIG. 11.

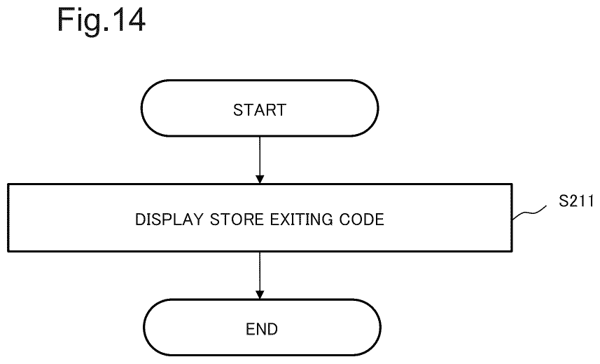

FIG. 14 is a flowchart illustrating an operation example of the terminal device 21 in a case where the paper coupon is issued. The output unit 211 displays the store exiting code under the control of the second output control unit 205 (step S211), and ends the processing.

Although not illustrated, when the store exiting information acquisition unit 201 receives the store exiting code, the second output control unit 205 may cause the terminal device 21 to end the display of the store exiting code. Then, the output unit 211 ends the display of the store exiting code.

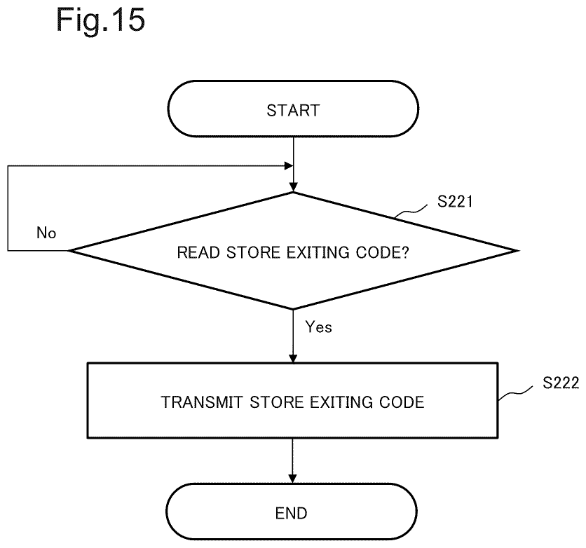

FIG. 15 is a flowchart illustrating an operation example of the reading device 22 in a case where the paper coupon is issued. From the terminal device 21, the reading device 22 determines whether the store exiting code is read (step S221). If the store exiting code has not been read (step S221: No), the reading device 22 returns to step S221. If the store exiting code has been read (step S221: Yes), the reading device 22 transmits the store exiting code to the store exiting management system 20 (step S222), and ends the processing.

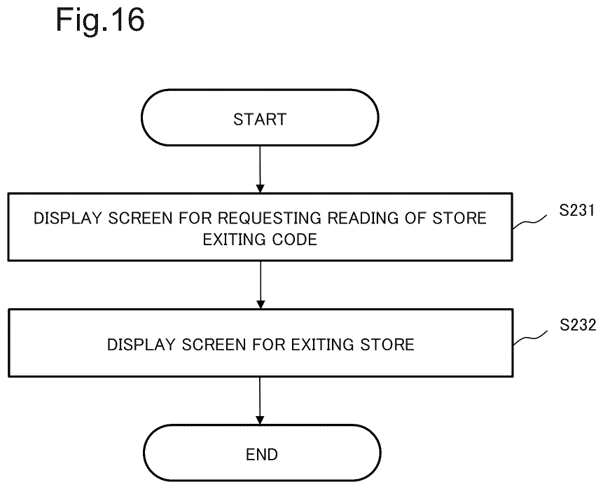

FIG. 16 is a flowchart illustrating an operation example of the display device 23 in a case where the paper coupon is issued. The display device 23 displays a screen for requesting reading of the store exiting code under the control of the first output control unit 204 (step S231). For example, an example of the screen in step S231 is the screen d301 illustrated in FIG. 7. Under the control of the first output control unit 204, the display device 23 displays the screen for exiting the store after the store exiting code is read (step S232), and ends the processing. In addition, examples of the screen for exiting the store include the screen d302 illustrated in 10 and the screen d303 illustrated in FIG. 11.

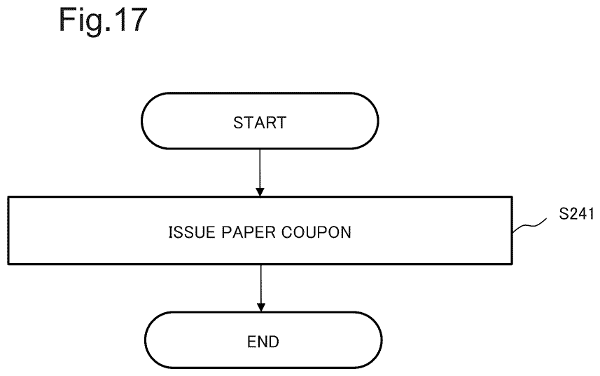

FIG. 17 is a flowchart illustrating an operation example of the printing device 24 in a case where the paper coupon is issued. The printing device 24 issues a paper coupon under the control of the granting unit 203 (step S241), and ends the processing.

### Operation Example in Case of Notifying Electronic Coupon

Next, an operation example of each device in a case where the granting unit 203 notifies the customer or the terminal device 21 of the customer of an electronic coupon will be described. Note that the reading device 22 and the display device 23 are the same as in the operation example in a case where the paper coupon is issued, and thus a detailed example will be omitted. Note that since the coupon is an electronic coupon, the operation of the printing device 24 used for printing a paper coupon will not be particularly described. Therefore, an operation example of each of the store exiting management system 20 and the terminal device 21 will be described.

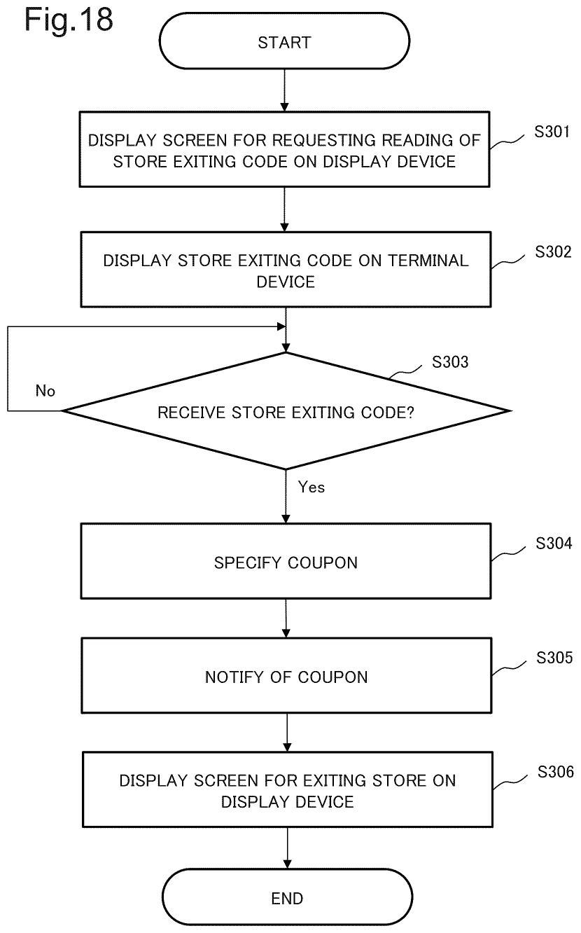

FIG. 18 is a flowchart illustrating an operation example of the store exiting management system 20 in a case where the electronic coupon is notified. Since the processing from step S301 to step S304 is the same as the processing from step S201 to step S204, the detailed description will be omitted.

After step S304, the granting unit 203 notifies the terminal device 21 of the coupon (step S305). Then, the first output control unit 204 displays a screen for exiting the store on the display device 23 (step S306), and ends the processing.

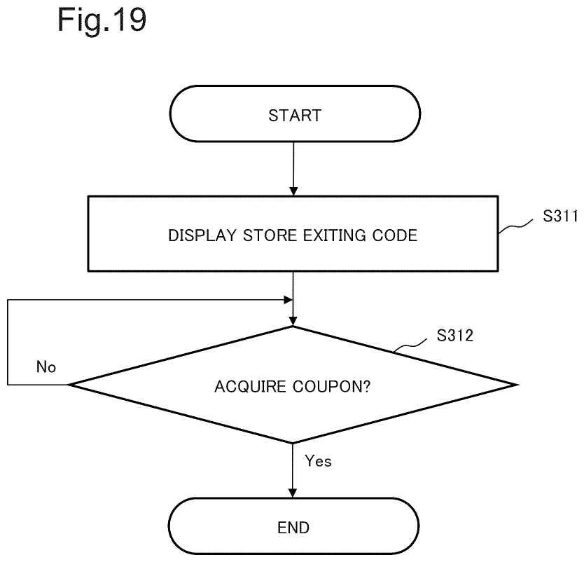

FIG. 19 is a flowchart illustrating an operation example of the terminal device 21 in a case where the electronic coupon is notified. The output unit 211 displays the store exiting code under the control of the second output control unit 205 (step S311). Next, the incentive acquisition unit 212 determines whether the coupon has been acquired (step S312). In step S312, the incentive acquisition unit 212 acquires the coupon by receiving the notification of the coupon. If the coupon has not been acquired (step S312: No), the incentive acquisition unit 212 returns to step S312. If the coupon has been acquired (step S312: Yes), the terminal device 21 ends the processing.

### Operation Example in Case of Acquiring Electronic Coupon Via Display Device 23

Next, an operation example of each device in a case where the granting unit 203 causes the display device 23 to display the coupon code of the electronic coupon and the terminal device 21 acquires the coupon via the display device 23 will be described. Note that the reading device 22 is the same as in the operation example in a case where the paper coupon is issued, and thus a detailed example is omitted. Note that since the coupon is an electronic coupon, the operation of the printing device 24 used for printing a paper coupon will not be particularly described. Therefore, an operation example of each of the store exiting management system 20, the terminal device 21, and the display device 23 will be described.

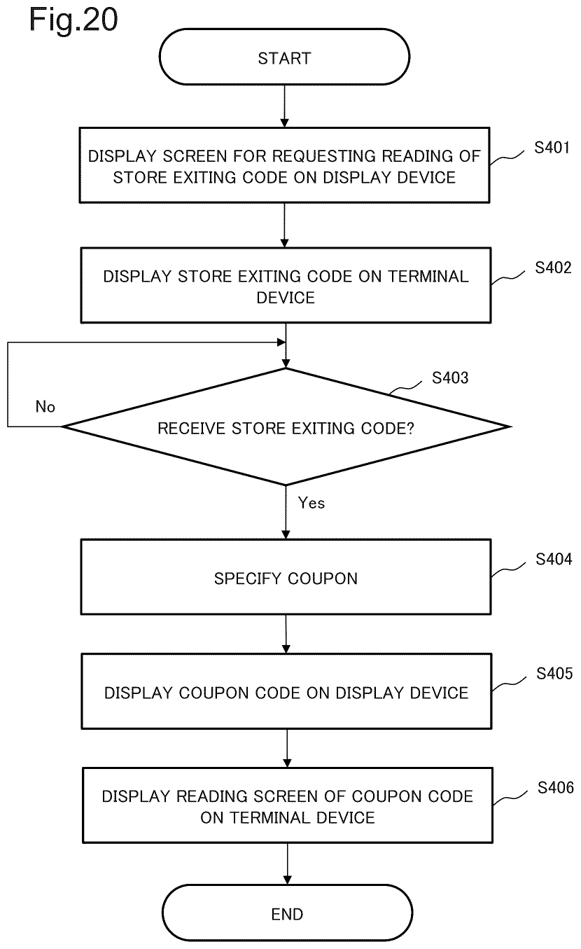

FIG. 20 is a flowchart illustrating an operation example of the store exiting management system 20 in a case where the electronic coupon is acquired via the display device 23. Since the processing from step S401 to step S404 is the same as the processing from step S201 to step S204, the detailed description will be omitted. After step S404, the granting unit 203 causes the display device 23 via the first output control unit 204 to display a coupon code from which the coupon can be acquired (step S405), and ends the processing. An example of the screen including the coupon code is the screen d304 illustrated in FIG. 12, for example.

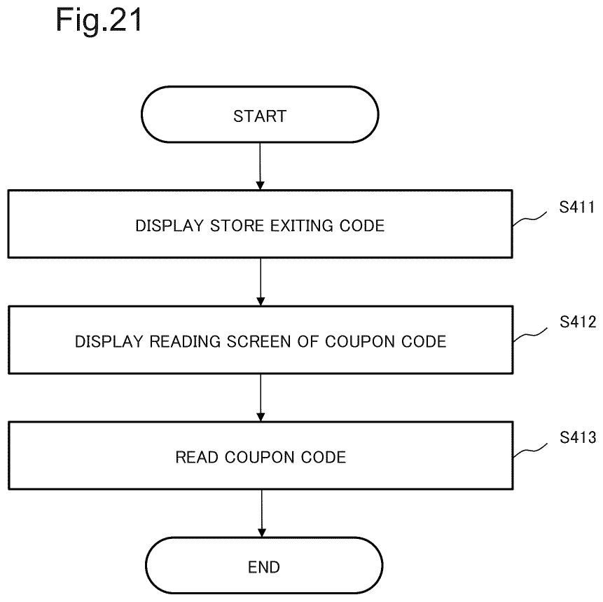

FIG. 21 is a flowchart illustrating an operation example of the terminal device 21 in a case where the electronic coupon is acquired via the display device 23. The output unit 211 displays the store exiting code under the control of the second output control unit 205 (step S411). Next, the output unit 211 displays a reading screen of the coupon code (step S412). The incentive acquisition unit 212 reads the coupon code displayed on the display device 23 by using the imaging device of the terminal device 21 (step S413). Accordingly, the incentive acquisition unit 212 can acquire the coupon represented by the coupon code. After step S413, the terminal device 21 ends the processing.

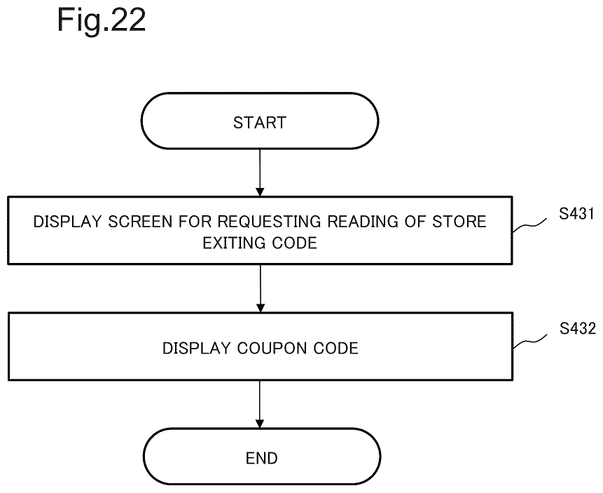

FIG. 22 is a flowchart illustrating an operation example of the display device 23 in a case where the electronic coupon is acquired via the display device 23. The display device 23 displays a screen for requesting reading of the store exiting code under the control of the first output control unit 204 (step S431). Next, the display device 23 displays the coupon code under the control of the first output control unit 204 (step S432). In step S432, the display device 23 displays a screen including the coupon code. An example of this screen is the screen d304 illustrated in FIG. 12, for example. After step S432, the display device 23 ends the processing.

In the above example, the processing at the time of exiting the store after payment completion has been described.

Next, for example, an example will be described in which a candidate of an incentive that the customer can obtain by causing the reading device 22 to read the store exiting code after payment completion is presented during product registration or the like. For example, in a case where the incentive corresponding to the purchase amount is specified, a candidate of the incentive may be displayed on the terminal device 21 during product registration by the customer via the terminal device 21.

For example, the product identification information acquisition unit 214 acquires product identification information for identifying a product that the customer intends to purchase. The product identification information is not particularly limited as long as the product identification information can uniquely identify the product, but a product code will be described as an example of the product identification information. The product code may be represented by a one-dimensional code or a two-dimensional code. In addition, a method in which the product identification information acquisition unit 214 acquires the product code is not particularly limited, but will be described by using an example in which the one-dimensional code is recognized via the imaging device of the terminal device 21 to acquire the product code represented by the one-dimensional code.

When reading the product code via the imaging device, the product identification information acquisition unit 214 transmits the product code to the store exiting management system 20. When receiving the product code, the registration unit 206 registers the product code in a list. In this manner, the product registration is performed. Note that this product registration processing is an example, and is not particularly limited.

Then, the specification unit 202 specifies a candidate of the incentive corresponding to the total amount of the products registered in the list. Then, the second output control unit 205 may cause the terminal device 21 to output the specified incentive candidate.

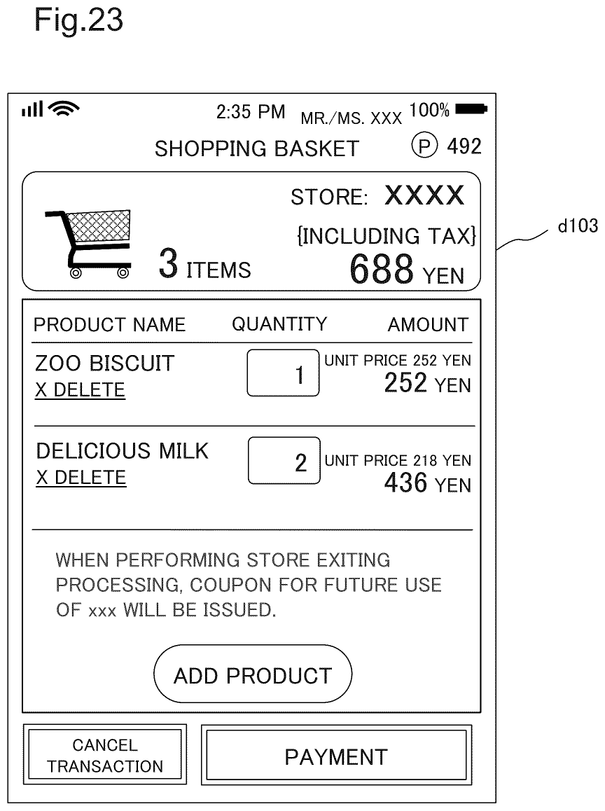

FIG. 23 is an explanatory diagram illustrating an example in which a candidate coupon is displayed on the terminal device 21 during product registration. The output unit 211 displays a list screen d103 including the specified coupon candidate on the display device of the terminal device 21. In FIG. 23, the list screen d103 displays that a coupon candidate is issued when the customer performs store exiting processing, for example, “When performing the store exiting processing, coupon(s) for future use of xxx will be issued.”. Note that the list screen d103 includes a list of registered products, a total amount of products, an “add product” button, a “cancel transaction” button, a “pay” button, and the like.

The “cancel transaction” button is a button for receiving a transaction cancel instruction. The transaction cancel instruction is an instruction for ending the transaction. For example, when the “cancel transaction” button is tapped, the operation reception unit 213 transmits the transaction cancel instruction to the store exiting management system 20. Accordingly, the transaction is ended.

For example, on the list screen d103, the product name of the registered product, the amount of payment for the product, and the purchase quantity are displayed as the list of products.

For example, the “add product” button is a button for receiving a reading instruction by the operation of the customer. The reading instruction is an instruction for newly reading identification information of a product. For example, when the “add product” button is tapped, the operation reception unit 213 transmits the reading instruction to the store exiting management system 20. Accordingly, a reading screen for reading a new product code is displayed on the terminal device 21.

In addition, the “pay” button is a button for receiving a payment instruction. The payment instruction is an instruction for starting payment by the operation of the customer. That is, accepting the payment instruction indicates that the product registration is ended. For example, when the “pay” button is tapped, the operation reception unit 213 transmits the payment instruction to the store exiting management system 20. Accordingly, the processing related to payment is started. Note that the payment may be made via the terminal device 21 or may be made via the settlement device. However, when the payment is made via the terminal device 21 by the operation of the customer, labor of the store clerk can be saved. In addition, when the payment is made via the terminal device 21 by the operation of the customer, the number of installed settlement devices can be reduced.

The example of FIG. 23 is an example in which the total amount satisfies an incentive granting condition. On the other hand, there is a case where the total amount does not satisfy the incentive granting condition. In such a case, the second output control unit 205 may cause the terminal device 21 to output the incentive granting condition in a case where the total amount does not satisfy the incentive granting condition. For example, in a case where the coupon granting condition is that the total amount is 1000 yen or more and the current total amount is less than 1000 yen, the second output control unit 205 may notify the terminal device 21 of the granting condition.

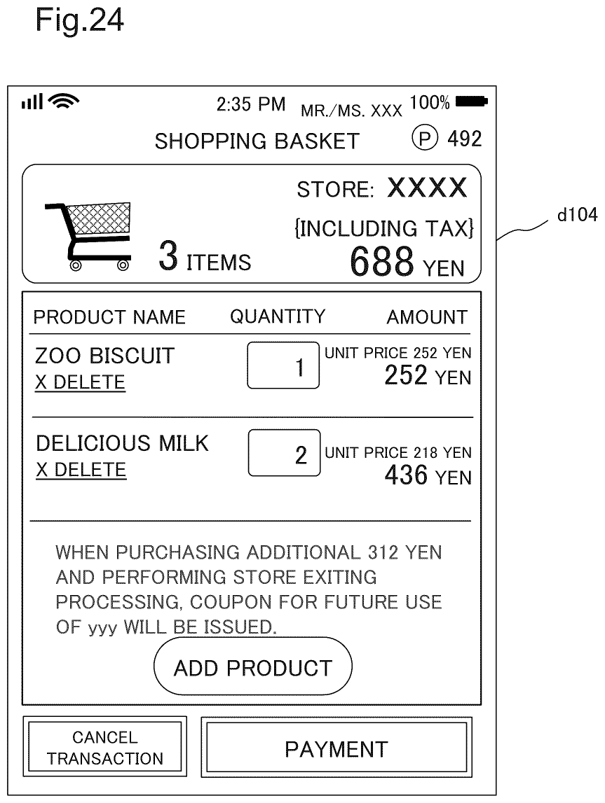

FIG. 24 is an explanatory diagram illustrating an example in which the coupon granting condition is displayed on the terminal device 21 during product registration. The output unit 211 displays a list screen d104 including the coupon granting condition on the display device of the terminal device 21. In FIG. 24, the list screen d104 displays that, when the coupon granting condition is satisfied, the coupon is issued by performing the store exiting processing, for example, “When purchasing additional 312 yen and performing store exiting processing, coupon(s) for future use of yyy will be issued.”. Note that other information included in the list screen d104 in FIG. 24 may be similar to the list screen d103 in FIG. 23, and a detailed description thereof will be omitted.

Note that the present invention is not limited to the example of the total amount, and the specification unit 202 may determine whether the coupon granting condition is satisfied. The second output control unit 205 may notify the terminal device 21 of the coupon candidate in a case where the coupon granting condition is satisfied, and may notify the terminal device 21 of the granting condition in a case where the coupon granting condition is not satisfied.

### Operation Example During Product Registration

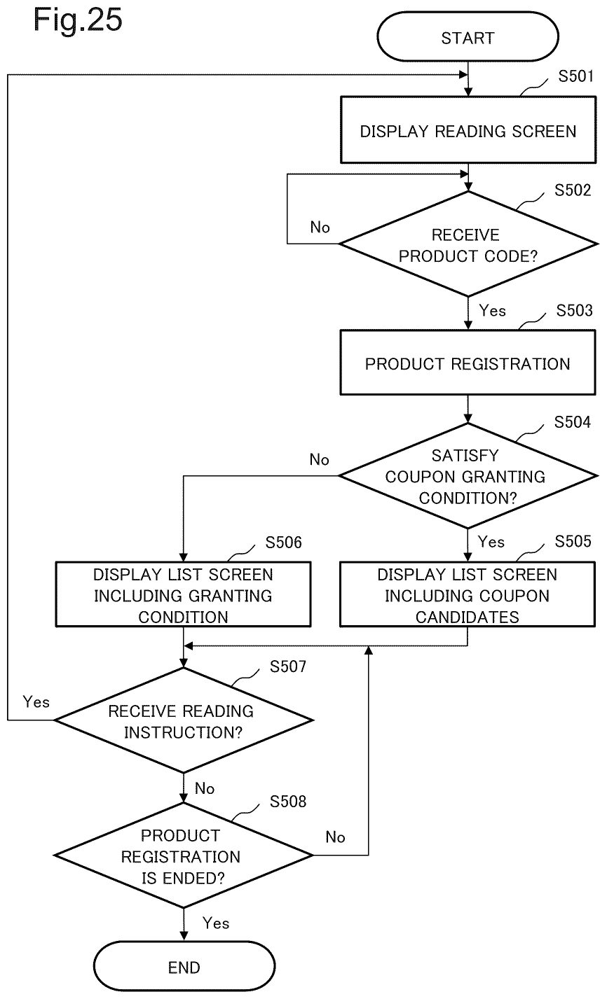

FIG. 25 is a flowchart illustrating an operation example of the store exiting management system 20 during product registration. The second output control unit 205 displays a reading screen on the terminal device 21 (step S501). The registration unit 206 determines whether a product code has been received from the terminal device 21 (step S502). If the product code has not been received (step S502: No), the registration unit 206 returns to step S502. If the product code has been received (step S502: Yes), the registration unit 206 performs product registration with the product code (step S503). Note that, for example, in step S503, the registration unit 206 performs the product registration by registering the product code in the list associated to the customer.

The specification unit 202 determines whether the coupon granting condition is satisfied (step S504). In step S504, for example, the specification unit 202 determines whether the total amount of the products registered as products satisfies the coupon granting condition. If the coupon granting condition is satisfied (step S504: Yes), the second output control unit 205 displays a list screen including coupon candidates on the terminal device 21 (step S505), and proceeds to step S507. An example of the list screen in step S505 is the list screen d103 illustrated in FIG. 23. If the coupon granting condition has not been satisfied (step S504: No), the second output control unit 205 displays a list screen including the granting condition on the terminal device 21 (step S506), and proceeds to step S507. An example of the list screen in step S506 is the list screen d104 illustrated in FIG. 24.

Next, the second output control unit 205 determines whether a reading instruction has been received (step S507). If the reading instruction has been received (step S507: Yes), the second output control unit 205 returns to step S501. If the reading instruction has not been received (step S507: Yes), the payment unit 207 determines whether the product registration has been ended (step S508). If the product registration has not been ended (step S507), the process returns to step S507.

If the product registration has been ended (step S508: Yes), the payment unit 207 performs payment or the like (not illustrated), and ends the processing. Note that the payment unit 207 performs the payment via the terminal device 21. Alternatively, the payment unit 207 performs the payment via the settlement device. In a case where an incentive is specified by the number of times of payment via the terminal device 21, the counting unit 208 counts the number of times for each customer and stores the counting result in the customer DB 2003.

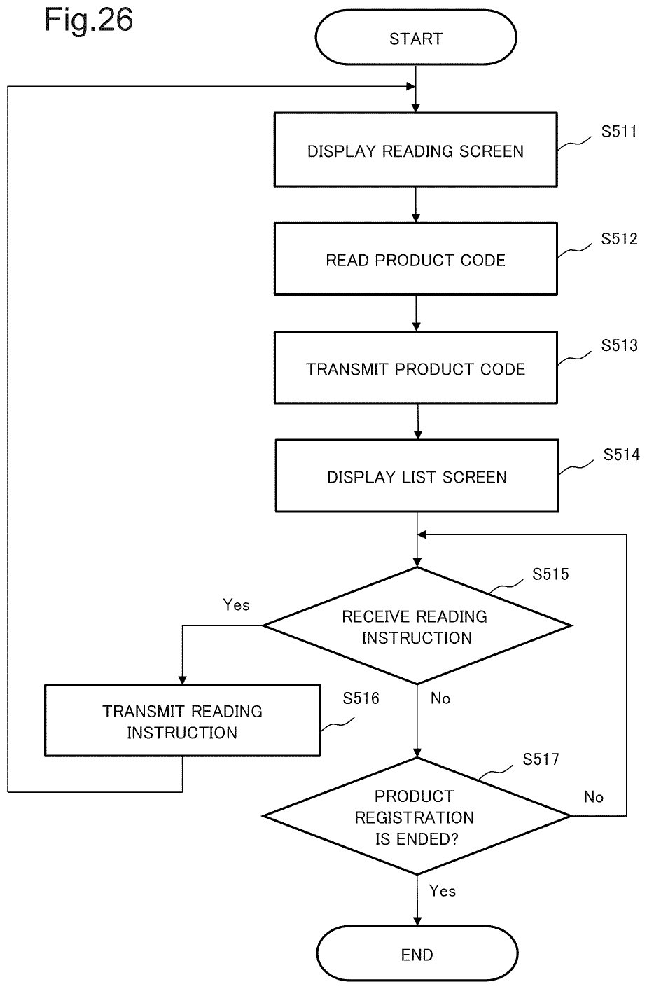

FIG. 26 is a flowchart illustrating an operation example of the terminal device 21 during product registration. In FIG. 26, the output unit 211 displays each screen under the control of the second output control unit 205.

The output unit 211 displays a reading screen (step S511). The product identification information acquisition unit 214 reads a product code (step S512). Then, the product identification information acquisition unit 214 transmits the product code (step S513). The output unit 211 displays a list screen (step S514). Here, the list screen is, for example, a list screen including coupon candidates or a list screen including a granting condition. As described above, an example of the list screen including the coupon candidates is the list screen d103 illustrated in FIG. 23. An example of the list screen including the granting condition is the list screen d104 illustrated in FIG. 24.

The operation reception unit 213 determines whether there is a new reading, depending on whether an operation such as a “read product” button has been received (step S515). If there is a new reading (step S515: Yes), the operation reception unit 213 transmits a reading instruction (step S516) and returns to step S511. If there is no new reading (step S515: No), the operation reception unit 213 determines whether the product registration is ended (step S517).

If the product registration has not been ended (step S517: No), the operation reception unit 213 returns to step S515. If the product registration is ended (step S517: Yes), the terminal device 21 ends the processing. Note that, in a case where payment is made via the terminal device 21, in the case of Yes in step S517, the terminal device 21 performs processing of receiving an operation related to payment, and the like.

As described above, in the second example embodiment, the customer may feel troublesome to perform the store exiting processing. With respect thereto, in a case where a store exiting code is acquired from the terminal device 21 of the customer, the store exiting management system 20 grants the incentive corresponding to the store exiting code to the customer. In this way, the incentive is granted with respect to the store exiting processing, so that it is possible to improve motivation of the customer to perform the store exiting processing. In addition, in the case of the store exiting counter without a gate as illustrated in FIG. 3, there is a case where the customer exits the store without performing the store exiting processing. With respect thereto, since an incentive is granted to the store exiting processing, the store exiting management system 20 can more reliably cause the customer to perform the store exiting processing.

The store exiting management system 20 may grant an incentive to the customer in a case where payment is made via the terminal device 21. Accordingly, it is possible to improve motivation for the customer to shop via the terminal device 21. Accordingly, it is possible to save labor of the store clerk. In addition, it is possible to reduce the number of installed settlement devices.

Alternatively, the store exiting management system 20 may specify an incentive depending on whether payment has been made via the terminal device 21. For example, the store exiting management system 20 specifies an incentive such that the incentive is higher in a case where payment is made via the terminal device 21 than in a case where payment is made via the settlement device. Accordingly, it is possible to improve motivation for the customer to shop via the terminal device 21.

The store exiting management system 20 specifies the incentive corresponding to the number of times of payment via the terminal device 21. The store exiting management system 20 specifies the incentive such that the incentive increases as the number of times increases. Accordingly, it is possible to improve motivation for the customer to shop via the terminal device 21.

The store exiting management system 20 specifies the incentive corresponding to the amount of payment. For example, the store exiting management system 20 specifies the incentive such that the higher the amount of payment, the higher the incentive. Accordingly, the sales can be improved.

The store exiting management system 20 specifies the incentive corresponding to the number of times the store exiting information has been acquired. The store exiting management system 20 specifies the incentive such that the incentive increases as the number of times increases. It is possible to more reliably cause the customer to perform the store exiting processing.

The store exiting management system 20 specifies the incentive corresponding to the member rank of the customer. Accordingly, in a case where the member rank is determined according to the purchase amount and the number of times of use of the customer in a predetermined period, the sales can be improved. In this case, the number of times of use of the store can be improved.

The incentive may be a coupon that can be used in subsequent transactions. The coupon may be a paper coupon or an electronic coupon.

Each example embodiment is not limited to the above-described examples, and various modifications can be made. For example, in the second example embodiment, a coupon is taken as an example of the incentive, but the type of incentive is not particularly limited. Here, modifications will be described.

### First Modification

In the second example embodiment, an example has been described in which the reading device 22, the display device 23, the printing device 24, and the like are installed in the store exiting counter. In a first modification, a case where a physical gate or the like is provided will be described as an example. As the gate, a flapper gate will be described as an example.

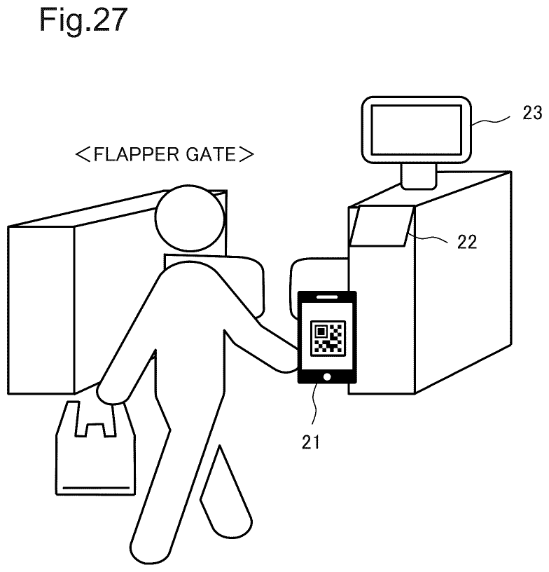

FIG. 27 is an explanatory diagram illustrating an example of performing store exiting processing in the flapper gate. The display device 23 and the reading device 22 are installed in the flapper gate. The display device 23 may display, for example, guidance to customers.

For example, after payment completion, the customer goes to the flapper gate before exiting the store. Then, the terminal device 21 operable by the customer displays a store exiting code. In FIG. 3, the store exiting code is represented by a two-dimensional code. The store exiting code is held over the reading device 22 by the customer. Then, the reading device 22 reads the store exiting code from the terminal device 21. In this manner, the store exiting processing is performed. In addition, after the store exiting processing is performed, the flapper gate opens. Note that the printing device 24 (not illustrated) may be installed in the flapper gate.

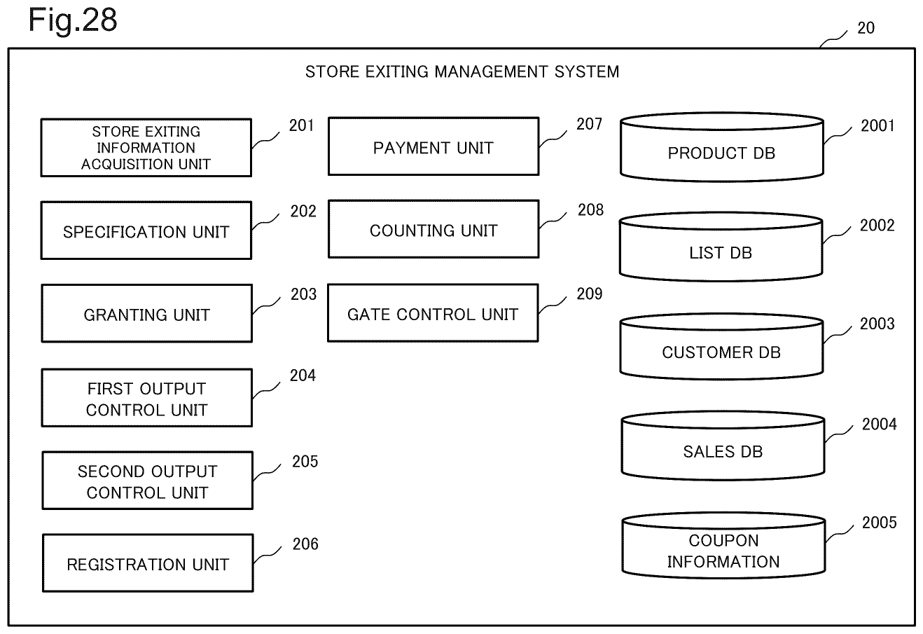

FIG. 28 is a block diagram illustrating a configuration example of the store exiting management system 20 according to the first modification. In the store exiting management system 20, a gate control unit 209 is further added to each functional unit illustrated in FIG. 5.

For example, the gate control unit 209 controls opening and closing of the flapper gate. For example, the gate control unit 209 may open the closed flapper gate after the store exiting information acquisition unit 201 acquires the store exiting code. For example, the flapper gate may be opened at such timing, for example, when an electronic coupon is notified.

For example, in the case of a paper coupon or in the case of the terminal device 21 acquiring an electronic coupon via the display device 23, if the flapper gate is opened before the coupon is granted, the customer may exit the store without receiving the coupon. Therefore, for example, the gate control unit 209 may open the flapper gate after the granting unit 203 grants the coupon.

The gate control unit 209 may detect the passage of the customer and close the flapper gate, or may close the flapper gate after a predetermined time has elapsed from the opening of the flapper gate.

### Second Modification

In the second example embodiment, an example has been described in which the first output control unit 204 controls the display of the display device. For example, the first output control unit 204 may control a voice output device such as a speaker installed in the store exiting counter. For example, the first output control unit 204 may cause guidance to the customer or a message to the customer to be output by voice.

In the second example embodiment, an example has been described in which the second output control unit 205 controls the display of the display device of the terminal device 21. For example, the second output control unit 205 may control the voice output device of the terminal device 21.

The description of each example embodiment and each modification is ended. Note that the example embodiments and the modifications described in the example embodiments may be used in combination. In addition, for example, in each example embodiment, the store exiting management system may include a part of the functional units and information.

As described above, the example embodiments and the modifications are not limited to the examples described above, and various modifications can be made. In addition, the configuration of the store exiting management system 20 in each example embodiment is not particularly limited. The store exiting management system may be achieved by one device or may be achieved by devices different for each function or database. In addition, the store exiting management system may also consist of some of these servers.

For example, a functional unit related to a specific application program such as the second output control unit 205 may be achieved by an application server. Then, for example, a functional unit related to a point of service (POS) such as the registration unit 206 and the payment unit 207 may be achieved by a POS server. The functional unit related to store exiting may be achieved by a server for store exiting management, and various DBs may be achieved by a database server.

For example, one terminal device 21 may include a functional unit of the store exiting management system described in each example embodiment.

A target of transmission/reception between devices such as the terminal device and the store exiting management system described in each example embodiment and modification may be information itself or an identifier representing information, and is not particularly limited.

In each example embodiment and modification, each table and information may include a part of the information described above. In addition, each table or information may include information other than the above-described information. Each table or information may be divided into a plurality of tables or a plurality of pieces of information in more detail. As described above, a method for achieving each table or information is not particularly limited.

Each screen is an example, and is not particularly limited. In each screen, the position, color, and size of each item such as a button, an input field, and a display field are not particularly limited. In each screen, a button, an information display field, an input field, and the like (not illustrated) may be added. In addition, the background color of the screen and the like may be changed.

For example, in each example embodiment and each modification, processing of generating information or the like of a screen to be displayed on the display device of the terminal device may be performed by the second output control unit of the store exiting management system or may be performed by the output unit of the terminal device.

The processing of generating information or the like of the screen to be displayed on the display device installed in the store may be performed by the first output control unit of the store exiting management system, or may be performed by the display device installed in the store.

### Hardware Configuration Example of Computer

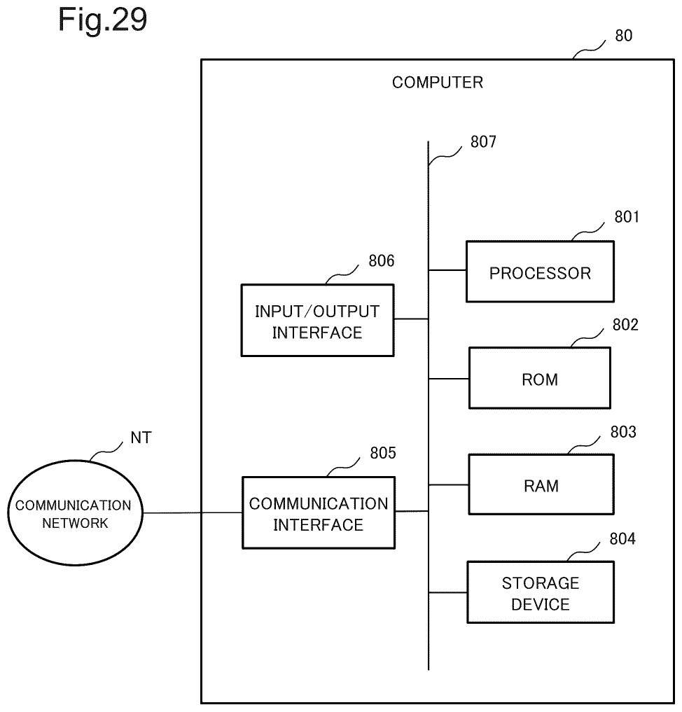

Next, a hardware configuration example in a case where each device such as the store exiting management system (server) and the terminal device described in each example embodiment is achieved by a computer will be described. FIG. 29 is an explanatory diagram illustrating a hardware configuration example of the computer. For example, some or all of the devices can be achieved by using a random combination of a computer 80 and the program as illustrated in FIG. 29, for example.

The computer 80 includes, for example, a processor 801, a read only memory (ROM) 802, a random access memory (RAM) 803, and a storage device 804. In addition, the computer 80 includes a communication interface 805 and an input/output interface 806. The components are connected to each other via, for example, a bus 807. The number of the components is not particularly limited. For example, the number of the components is one or more.

The processor 801 controls the entire computer 80. Examples of the processor 801 include a central processing unit (CPU), a digital signal processor (DSP), and a graphics processing unit (GPU). As described above, the number of processors 801 is not particularly limited, and the number of the processors 801 is one or more. The computer 80 includes the ROM 802, the RAM 803, the storage device 804, and the like as storage units. Examples of the storage device 804 include a semiconductor memory such as a flash memory, a hard disk drive (HDD), a solid state drive (SSD), and the like. For example, the storage device 804 stores an operating system (OS) program, an application program, a program according to each example embodiment, and the like. Alternatively, the ROM 802 stores an application program, a program according to each example embodiment, and the like. Then, the RAM 803 is used as a work area of the processor 801. Note that as described above, the number of each of ROMs 802, RAMs 803, and storage devices 804 is not particularly limited, and the number of each of the ROMs 802, the RAMs 803, and the storage devices 804 is one or more.

The processor 801 loads the program stored in the storage device 804, the ROM 802, or the like. Then, the processor 801 executes each processing coded in the program. In addition, the processor 801 may download various programs via a communication network. In addition, the processor 801 functions as a part or the whole of the computer 80. Then, the processor 801 may execute processing or instructions in the illustrated flowchart based on the program.

The communication interface 805 is connected to a communication network NT such as a local area network (LAN) or a wide area network (WAN) through a wireless or wired communication line. Note that the communication network may include a plurality of communication networks. Accordingly, the computer 80 is connected to an external device or an external computer 80 via a communication network. The communication interface 805 manages an interface between the communication network NT and the inside of the computer 80. Then, the communication interface 805 controls input and output of data from the external device or the external computer 80.

The input/output interface 806 is connected to at least one of an input device, an output device, and an input/output device. A connection method may be wireless or may be wired. Examples of the input device include a keyboard, a mouse, and a microphone. Examples of the output device include a display device, a lighting device, and a speaker that outputs voice. In addition, examples of the input/output device include a touch panel display. Note that the input device, the output device, the input/output device, and the like may be built in the computer 80 or may be externally attached.

The hardware configuration of the computer 80 is an example. The computer 80 may have some components illustrated in FIG. 29. The computer 80 may have components other than those illustrated in FIG. 29. For example, the computer 80 may include a drive device or the like. Then, the processor 801 may read, into the RAM 803, a program or data stored in a recording medium attached to a drive device or the like. Examples of the non-transitory tangible recording medium include an optical disk, a flexible disk, a magnetic optical disk, and a universal serial bus (USB) memory. In addition, as described above, for example, the computer 80 may include an input device such as a keyboard and a mouse. The computer 80 may have an output device such as a display. In addition, the computer 80 may include an input device, an output device, and an input/output device.

The computer 80 may include various sensors (not illustrated). The type of the sensor is not particularly limited. Examples of the sensor include an acceleration sensor, a gyro sensor, a magnetic sensor, a global positioning system (GPS), and a sensor. Examples of the sensor include a fingerprint sensor, LiDAR (Light, Detection and Ranging), a proximity sensor, and an ambient light sensor.

Here, the description of the hardware configuration of each device is ended. In addition, there are various modifications of the achieving method of each device. For example, the store exiting management system may be achieved by a random combination of a computer and a program different for each component. In addition, a plurality of components included in each device may be achieved by a random combination of one computer and a program.

Some or all of the components of the devices may be achieved by an application specific circuit. In addition, a part or the whole of each device may be achieved by a general-purpose circuit including a processor such as a field programmable gate array (FPGA). In addition, a part or the whole of each device may be achieved by a combination of an application specific circuit, a general-purpose circuit, or the like. In addition, these circuits may be a single integrated circuit. Alternatively, these circuits may be divided into a plurality of integrated circuits. The plurality of integrated circuits may be configured by being connected via a bus or the like.

In addition, in a case where a part or the whole of each component of each device is achieved by a plurality of computers, circuits, and the like, the plurality of computers, circuits, and the like may be arranged in a centralized manner or in a distributed manner.

The store exiting management method described in each example embodiment is achieved by execution of each device such as the store exiting management system. The store exiting management method is achieved by a computer such as the terminal device or the store exiting management system (server) executing a program prepared in advance. The program described in each example embodiment is recorded in a computer-readable recording medium such as an HDD, an SSD, a flexible disk, an optical disk, a flexible disk, a magnetic optical disk, or a USB memory. Then, the program is executed by being read from the recording medium by the computer. In addition, the program may be distributed via the communication network NT.

The function of each component of each device in each example embodiment described above may be achieved as hardware like a computer. Alternatively, each component may be achieved by a computer or firmware based on program control.

While the present disclosure has been particularly shown and described with reference to exemplary embodiments thereof, the present disclosure is not limited to these embodiments. The configuration and details of each of the present disclosure may include example embodiments to which various changes that can be grasped by those of ordinary skill in the art without departing from the spirit and the scope of the present disclosure are applied. The present disclosure may include example embodiments in which the matters described in the present specification are appropriately combined or replaced as necessary. For example, the matters described using a specific example embodiment can be applied to other example embodiments as long as no contradiction occurs. For example, although a plurality of operations are described in order in the form of a flowchart, the order of description does not limit the order of executing the plurality of operations. Therefore, when each example embodiment is implemented, the order of the plurality of operations can be changed within a range that does not interfere with the content.

Some or all of the above-described example embodiments can also be described as the following supplementary notes. However, some or all of the above-described example embodiments are not limited to the following.

### Supplementary Note 1

A store exiting management system including:
a store exiting information acquisition means for acquiring store exiting information from a terminal device after a product is registered via an operation of a customer on the terminal device and payment of the registered product is completed;
a specification means for specifying an incentive corresponding to the acquired store exiting information; and
a granting means for granting the specified incentive to the customer.

### Supplementary Note 2

The store exiting management system according to supplementary note 1, wherein
the payment is made via the terminal device.

### Supplementary Note 3

The store exiting management system according to supplementary note 1, wherein
the specification means specifies the incentive depending on whether the payment has been made via the terminal device.

### Supplementary Note 4

The store exiting management system according to supplementary note 3, wherein
the specification means specifies the incentive such that the incentive is higher in a case where the payment is made via the terminal device than in a case where the payment is made via a settlement device.

### Supplementary Note 5

The store exiting management system according to supplementary note 1 or 2, wherein
the specification means specifies the incentive corresponding to an amount of the payment.

### Supplementary Note 6

The store exiting management system according to supplementary note 1 or 2, wherein
the specification means specifies the incentive corresponding to a number of times the payment has been made via the terminal device.

### Supplementary Note 7

The store exiting management system according to supplementary note 6, wherein
the specification means specifies the incentive such that the incentive becomes higher as the number of times the payment has been made via the terminal device increases.

### Supplementary Note 8

The store exiting management system according to supplementary note 1 or 2, wherein
the specification means specifies the incentive corresponding to a number of times the store exiting information has been acquired.

### Supplementary Note 9

The store exiting management system according to supplementary note 8, wherein
the specification means specifies the incentive such that the incentive becomes higher as the number of times the store exiting information has been acquired increases.

### Supplementary Note 10

The store exiting management system according to supplementary note 1 or 2, wherein
the store exiting information includes customer identification information for identifying the customer, and
the specification means specifies the incentive corresponding to a member rank of the customer specified by the customer identification information.

### Supplementary Note 11

The store exiting management system according to any one of supplementary notes 1 to 10, wherein
the incentive is a coupon that is usable in subsequent transactions.

### Supplementary Note 12

The store exiting management system according to supplementary note 11, wherein
the coupon is a paper coupon, and
the granting means prints the coupon with a printing device.

### Supplementary Note 13

The store exiting management system according to supplementary note 11, wherein
the coupon is an electronic coupon, and
the granting means notifies the terminal device of the coupon.

### Supplementary Note 14

The store exiting management system according to supplementary note 11, further including:
a first output control means for controlling output of a display device installed in a store, wherein
the coupon is an electronic coupon, and
the granting means causes, via the first output control means, the display device installed in the store to display a code from which the terminal device is capable of acquiring the coupon.

### Supplementary Note 15

The store exiting management system according to any one of supplementary notes 1 to 14, wherein
the store exiting information includes customer identification information for identifying the customer, the store exiting management system further including:
a first output control means for displaying information of the customer specified by the customer identification information on a display device installed in a store.

### Supplementary Note 16

A store exiting management method including:
acquiring store exiting information from a terminal device after a product is registered via an operation of a customer on the terminal device and payment of the registered product is completed;
specifying an incentive corresponding to the acquired store exiting information; and
granting the specified incentive to the customer.

### Supplementary Note 17

A non-transitory computer-readable recording medium having recorded thereon a program that causes a computer to execute processing including:
acquiring store exiting information from a terminal device after a product is registered via an operation of a customer on the terminal device and payment of the registered product is completed;
specifying an incentive corresponding to the acquired store exiting information; and
granting the specified incentive to the customer.

### Supplementary Note 18

A program according to an aspect of the present disclosure causes a computer to execute processing including: acquiring store exiting information from a terminal device after a product is registered via an operation of a customer on the terminal device and payment of the registered product is completed; specifying an incentive corresponding to the acquired store exiting information; and granting the specified incentive to the customer.

### REFERENCE SIGNS LIST

10, 20 store exiting management system
21 terminal device
22 reading device
23 display device
24 printing device
80 computer
101, 201 store exiting information acquisition unit
102, 202 specification unit
103, 203 granting unit
204 first output control unit
205 second output control unit
206 registration unit
207 payment unit
208 counting unit
209 gate control unit
2001 product DB
2002 list DB
2003 customer DB
2004 sales DB
2005 coupon information
211 output unit
212 incentive acquisition unit
213 operation reception unit
214 product identification information acquisition unit
801 processor
802 ROM
803 RAM
804 storage device
805 communication interface
806 input/output interface
807 bus
d101 screen
d102 screen
d103 list screen
d104 list screen
d301 screen
d302 screen
d303 screen
d304 screen
NT communication network

What is claimed is:

1. A store exiting management system comprising:
at least one memory storing instructions; and
at least one processor configured to execute the instructions to:
acquire store exiting information from a terminal device after a product is registered via an operation of a customer on the terminal device and payment of the registered product is completed;
specify an incentive corresponding to the acquired store exiting information; and
grant the specified incentive to the customer.

2. The store exiting management system according to claim 1, wherein
the payment is made via the terminal device.

3. The store exiting management system according to claim 1, wherein the at least one processor is further configured to execute the instructions to:
specify the incentive depending on whether the payment has been made via the terminal device.

4. The store exiting management system according to claim 3, wherein the at least one processor is further configured to execute the instructions to:
specify the incentive such that the incentive is higher in a case where the payment is made via the terminal device than in a case where the payment is made via a settlement device.

5. The store exiting management system according to claim 1, wherein the at least one processor is further configured to execute the instructions to:
specify the incentive corresponding to an amount of the payment.

6. The store exiting management system according to claim 1, wherein the at least one processor is further configured to execute the instructions to:
specify the incentive corresponding to a number of times the payment has been made via the terminal device.

7. The store exiting management system according to claim 6, wherein the at least one processor is further configured to execute the instructions to:
specify the incentive such that the incentive becomes higher as the number of times the payment has been made via the terminal device increases.

8. The store exiting management system according to claim 1, wherein the at least one processor is further configured to execute the instructions to:
specify the incentive corresponding to a number of times the store exiting information has been acquired.

9. The store exiting management system according to claim 8, wherein the at least one processor is further configured to execute the instructions to:
specify the incentive such that the incentive becomes higher as the number of times the store exiting information has been acquired increases.

10. The store exiting management system according to claim 1, wherein
the store exiting information includes customer identification information for identifying the customer, wherein the at least one processor is further configured to execute the instructions to:
specify the incentive corresponding to a member rank of the customer specified by the customer identification information.

11. The store exiting management system according to claim 1, wherein
the incentive is a coupon that is usable in subsequent transactions.

12. The store exiting management system according to claim 11, wherein
the coupon is a paper coupon, wherein the at least one processor is further configured to execute the instructions to:
print the coupon with a printing device.

13. The store exiting management system according to claim 11, wherein
the coupon is an electronic coupon, wherein the at least one processor is further configured to execute the instructions to:
notify the terminal device of the coupon.

14. The store exiting management system according to claim 11, wherein the at least one processor is further configured to execute the instructions to:
control output of a display device installed in a store, wherein
the coupon is an electronic coupon; and
display on the display device installed in the store a code from which the terminal device is capable of acquiring the coupon.

15. The store exiting management system according to claim 1, wherein
the store exiting information includes customer identification information for identifying the customer, wherein the at least one processor is further configured to execute the instructions to:
display information of the customer specified by the customer identification information on a display device installed in a store.

16. A store exiting management method comprising:
acquiring store exiting information from a terminal device after a product is registered via an operation of a customer on the terminal device and payment of the registered product is completed;
specifying an incentive corresponding to the acquired store exiting information; and
granting the specified incentive to the customer.

17. A non-transitory computer-readable recording medium having recorded thereon a program that causes a computer to execute processing comprising:
acquiring store exiting information from a terminal device after a product is registered via an operation of a customer on the terminal device and payment of the registered product is completed;
specifying an incentive corresponding to the acquired store exiting information; and
granting the specified incentive to the customer.
